(19) United States
(12) Patent Application Publication
(10) Pub. No.: US 2020/0108539 A1
(43) Pub. Date: Apr. 9, 2020

(54) Cast Films and Processes for Making the Same

(71) Applicant: ExxonMobil Chemica Patents Inc., Baytown, TX (US)

(72) Inventors: Michael G. Williams, Houston, TX (US); Sushanta Dhar Roy, Houston, TX (US)

(21) Appl. No.: 16/499,853

(22) PCT Filed: Mar. 23, 2018
(86) PCT No.: PCT/US2018/023923

§ 371 Date: Sep. 30, 2019

Related U.S. Application Data
(60) Provisional application No. 62/482,393, filed on Apr. 6, 2017.

(51) Int. Cl. B29C 48/07; B29C 48/88

(52) U.S. Cl. CPC B29C 48/07; B29K 2023/06; B29K 2995/0037; B29C 48/914

(57) ABSTRACT

Cast films made from metallocene-catalyzed polyethylene polymers, optionally, with other polymers, and processes for making the same, are disclosed.

### CROSS REFERENCE TO RELATED APPLICATIONS

This application claims the benefit of Ser. No. 62/482,393, filed Apr. 6, 2017, the disclosure of which is hereby incorporated by reference in its entirety.

### FIELD OF THE INVENTION

The present invention generally relates to cast films made from metallocene-catalyzed polyethylene polymers, optionally, including other polymers, and processes for making the same.

### BACKGROUND OF THE INVENTION

Metallocene polyethylene (mPE) resins such as those available from ExxonMobil Chemical Company, Houston, Tex., have revolutionized the plastics industry by improving upon polymer properties that have enhanced several end use applications and created several new applications. In general, mPE provides for a good balance of operational stability, extended output, versatility with higher alpha olefin (HAO) performance, toughness and strength, good optical properties, down gauging opportunities, and resin sourcing simplicity. See, for example, U.S. Ser. No. 62/313,502, filed Mar. 25, 2016; U.S. Publication Nos. 2009/0297810; 2015/0291748; U.S. Pat. No. 6,956,088; and WO 2014/099356. However, for certain applications, more improvements are still required.

In particular, a class of metallocene-catalyzed polyethylene polymers such as EXCEED XP™ Performance Polymers, available from ExxonMobil Chemical Company, offers improved mechanical properties and downgauging opportunities for end-use articles such as films in the areas of dart drop impact resistance and tear strength. See, for example, U.S. Pat. Nos. 6,242,545; 6,248,845; and 6,956,088. Other background references include U.S. Pat. Nos. 4,780,264; 5,677,375; 9,321,911; and U.S. Publication Nos. 2015/0225520 and 2015/0376354.

U.S. Publication No. 2015/0291748 discloses a number of polyethylene polymers, “PE1-PE6,” made according to U.S. Pat. No. 6,956,088. It also discloses, among other things, a cast film, consisting essentially of: a) a Layer A comprising 90.0 wt % to 100.0 wt %, based on the weight of the film of an ethylene-based polymer, the ethylene-based polymer composition having a hafnium:zirconium (ppm/ppm) ratio >1.0, a CDBI less than 50%, and a g′vis≥0.98; wherein the film is substantially free of a polyethylene having 0.50≤g′vis≤0.85, and wherein the film has a Dart A Impact Strength of 400.0 to 1400.0 g/mil and an MD Elmendorf Tear of 400.0 to 2000.0 g/mil.

Typically, high melt index (MI) (I_{2.16} or simply O₂ for shorthand according to ASTM D1238, condition E (190° C./2.16 kg)) polyethylene polymers are chosen for cast films because their production lines run at such high rates, for example, 1,000 lb/hr or higher.

However, there remains a need for improvements for cast films and processes for making them. Such cast films should demonstrate a good balance of one or more of the following properties: dart drop impact strength, tear strength or resistance, down gauging possibilities, and puncture resistance.

### SUMMARY OF THE INVENTION

In a class of embodiments, the invention provides for a cast film comprising the product of the combination of: a) a core layer comprising at least one first polyethylene polymer having a melt index of 4.0 g/10 min or less, wherein the at least one first polyethylene polymer has an orthogonal comonomer distribution and/or has at least a first peak and at least a second peak in a comonomer distribution analysis; and b) one or more skin layers comprising at least one second polyethylene polymer having a melt index of 4.2 g/10 min or greater.

In another class of embodiments, the invention provides for a process to produce a cast film, the process comprising: a) melt extruding at least one first polyethylene polymer to form a molten polymer; b) passing the molten polymer through a die to form the cast film; c) cooling the cast film using one or more chill rolls; d) optionally, annealing the cast film and/or treating the cast film with a corona treatment; and e) recovering the cast film; wherein the at least one first polyethylene polymer has a melt index 4.0 g/10 min or less, an orthogonal comonomer distribution, and/or has at least a first peak and at least a second peak in a comonomer distribution analysis.

In any of the embodiments described herein, the at least one first polyethylene polymer may have a melt index of from 0.1 g/10 min to 3.5 g/10 min, a melt index of from 0.1 g/10 min to 2.0 g/10 min, or a melt index of from 0.2 g/10 min to 1.0 g/10 min.

In any of the embodiments described herein, the at least one second polyethylene polymer may have a melt index of from 4.5 g/10 min to 10.0 g/10 min, a melt index of from 4.5 g/10 min to 9.0 g/10 min, or a melt index of from 4.5 g/10 min to 7.0 g/10 min.

Other embodiments of the invention are described, claimed herein, and are apparent by the following disclosure.

### DETAILED DESCRIPTION OF ILLUSTRATIVE EMBODIMENTS

Before the present polymers, compounds, components, compositions, and/or methods are disclosed and described, it is to be understood that unless otherwise indicated this invention is not limited to specific polymers, compounds, components, compositions, reactants, reaction conditions, ligands, metallocene structures, or the like, as such may vary, unless otherwise specified. It is also to be understood that the terminology used herein is for the purpose of describing particular embodiments only and is not intended to be limiting.

### Definitions

For the purposes of this disclosure, the following definitions will apply, unless otherwise stated. Molecular weight distribution (“MWD”) is equivalent to the expression M_{w}/Mₙ. The expression M_{w}/Mₙ is the ratio of the weight average molecular weight (M_{w}) to the number average molecular weight (Mₙ). The weight average molecular weight is given by

$${M}_{w} = \frac{{\sum }_{i} {n}_{i} {M}_{i}^{2}}{{\sum }_{i} {n}_{i} {M}_{i}} ,$$

the number average molecular weight is given by

$${M}_{n} = \frac{{\sum }_{i} {n}_{i} {M}_{i}}{{\sum }_{i} {n}_{i}} ,$$

and, the z-average molecular weight is given by

$${M}_{z} = \frac{{\sum }_{i} {n}_{i} {M}_{i}^{3}}{{\sum }_{i} {n}_{i} {M}_{i}^{2}} ,$$

where nᵢ in the foregoing equations is the number fraction of molecules of molecular weight Mᵢ. Measurements of M_{w}, M_{z}, and Mₙ are determined by Gel Permeation Chromatography. The measurements proceed as follows. Gel Permeation Chromatography (Agilent PL-220), equipped with three in-line detectors, a differential refractive index detector (DRI), a light scattering (LS) detector, and a viscometer, and is used. Experimental details, including detector calibration, are described in: T. Sun, P. Brant, R. R. Chance, and W. W. Graessley, Macromolecules, Volume 34, Number 19, pp. 6812-6820, (2001). Three Agilent PLgel 10 μm Mixed-B LS columns are used. The nominal flow rate is 0.5 mL/min, and the nominal injection volume is 300 μL. The various transfer lines, columns, viscometer and differential refractometer (the DRI detector) are contained in an oven maintained at 145° C. Solvent for the experiment is prepared by dissolving 6 grams of butylated hydroxytoluene as an antioxidant in 4 liters of Aldrich reagent grade 1,2,4-trichlorobenzene (TCB). The TCB mixture is then filtered through a 0.1 μm Teflon filter. The TCB is then degassed with an online degasser before entering the GPC-3D. Polymer solutions are prepared by placing dry polymer in a glass container, adding the desired amount of TCB, then heating the mixture at 160° C. with continuous shaking for about 2 hours. All quantities are measured gravimetrically. The TCB densities used to express the polymer concentration in mass/volume units are 1.463 g/ml at about 21° C. and 1.284 g/ml at 145° C. The injection concentration is from 0.5 to 2.0 mg/ml, with lower concentrations being used for higher molecular weight samples. Prior to running each sample, the DRI detector and the viscometer are purged. The flow rate in the apparatus is then increased to 0.5 ml/minute, and the DRI is allowed to stabilize for 8 hours before injecting the first sample. The LS laser is turned on at least 1 to 1.5 hours before running the samples. The concentration, c, at each point in the chromatogram is calculated from the baseline-subtracted DRI signal, I_{DRI}, using the following equation:

c=K_{DRI}I_{DRI}/(dn/dc),

where K_{DRI} is a constant determined by calibrating the DRI, and (dn/dc) is the refractive index increment for the system. The refractive index, n=1.500 for TCB at 145° C. and λ=690 nm. Units on parameters throughout this description of the GPC-3D method are such that concentration is expressed in g/cm³, molecular weight is expressed in g/mole, and intrinsic viscosity is expressed in dL/g.

The LS detector is a Wyatt Technology High Temperature DAWN HELEOS. The molecular weight, M, at each point in the chromatogram is determined by analyzing the LS output using the Zimm model for static light scattering (M. B. Huglin, LIGHT SCATTERING FROM POLYMER SOLUTIONS, Academic Press, 1971):

$$\frac{{K}_{o} c}{Δ R ( θ )} = \frac{1}{MP ( θ )} + 2 {A}_{2} c .$$

Here, ΔR(θ) is the measured excess Rayleigh scattering intensity at scattering angle θ, c is the polymer concentration determined from the DRI analysis, and A2 is the second virial coefficient. P(θ) is the form factor for a monodisperse random coil, and K₀ is the optical constant for the system:

$${K}_{o} = \frac{4 {π}^{2} {{n}^{2} ( dn / dc )}^{2}}{{λ}^{4} {N}_{A}} ,$$

where N_{A} is Avogadro's number, and (dn/dc) is the refractive index increment for the system, which take the same value as the one obtained from DRI method. The refractive index, n=1.500 for TCB at 145° C. and λ=657 nm.

A high temperature Viscotek Corporation viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the following equation:

ηₛ=c[η]+0.3(c[η])²,

where c is concentration and was determined from the DRI output.

The branching index (g′ᵥᵢₛ) is calculated using the output of the GPC-DRI-LS-VIS method as follows. The average intrinsic viscosity, [η]_{avg}, of the sample is calculated by:

$${[ η ]}_{avg} = \frac{\sum {{c}_{i} [ η ]}_{i}}{\sum {c}_{i}} ,$$

where the summations are over the chromatographic slices, i, between the integration limits.

The branching index g′ᵥᵢₛ is defined as:

$${g}^{′} vis = \frac{{[ η ]}_{avg}}{{kM}_{v}^{α}} ,$$

M_{V} is the viscosity-average molecular weight based on molecular weights determined by LS analysis. Z average branching index (g′zₐᵥₑ) is calculated using Ci=polymer concentration in the slice i in the polymer peak times the mass of the slice squared, Mi². All molecular weights are weight average, unless otherwise noted. All molecular weights are reported in g/mol, unless otherwise noted. This method is the preferred method of measurement and used in the examples and throughout the disclosures unless otherwise specified. See also, for background, Sun et al., “Effect of Short Chain Branching on the Coil Dimensions of Polyolefins in Dilute Solution”, Macromolecules, Vol. 34, No. 19, pg. 6812-6820 (2001).

The broadness of the composition distribution of the polymer may be characterized by T₇₅-T₂₅. TREF is measured using an analytical size TREF instrument (Polymerchar, Spain), with a column of the following dimensions: inner diameter (ID) 7.8 mm, outer diameter (OD) 9.53 mm, and column length of 150 mm. The column may be filled with steel beads. 0.5 mL of a 4 mg/ml polymer solution in orthodichlorobenzene (ODCB) containing 2 g BHT/4 L were charge onto the column and cooled from 140° C. to −15° C. at a constant cooling rate of 1.0° C./min. Subsequently, ODCB may be pumped through the column at a flow rate of 1.0 ml/min, and the column temperature may be increased at a constant heating rate of 2° C./min to elute the polymer. The polymer concentration in the eluted liquid may then be detected by means of measuring the absorption at a wavenumber of 2941 cm⁻¹ using an infrared detector. The concentration of the ethylene-α-olefin copolymer in the eluted liquid may be calculated from the absorption and plotted as a function of temperature.

### Polyethylene Polymer

The polyethylene polymer comprises from 70.0 mole % to 100.0 mole % of units derived from ethylene. The lower limit on the range of ethylene content may be from 70.0 mole %, 75.0 mole %, 80.0 mole %, 85.0 mole %, 90.0 mole %, 92.0 mole %, 94.0 mole %, 95.0 mole %, 96.0 mole %, 97.0 mole %, 98.0 mole %, or 99.0 mole % based on the mole % of polymer units derived from ethylene. The polyethylene polymer may have an upper ethylene limit of 80.0 mole %, 85.0 mole %, 90.0 mole %, 92.0 mole %, 94.0 mole %, 95.0 mole %, 96.0 mole %, 97.0 mole %, 98.0 mole %, 99.0 mole %, 99.5 mole %, or 100.0 mole %, based on polymer units derived from ethylene. For polyethylene copolymers, the polyethylene polymer may have less than 50.0 mole % of polymer units derived from a C₃-C₂₀ olefin, preferably, an alpha-olefin, e.g., hexene or octene. The lower limit on the range of C₃-C₂₀ olefin-content may be 25.0 mole %, 20.0 mole %, 15.0 mole %, 10.0 mole %, 8.0 mole %, 6.0 mole %, 5.0 mole %, 4.0 mole %, 3.0 mole %, 2.0 mole %, 1.0 mole %, or 0.5 mole %, based on polymer units derived from the C₃-C₂₀ olefin. The upper limit on the range of C₃-C₂₀ olefin-content may be 35.0 mole %, 30.0 mole %, 25.0 mole %, 20.0 mole %, 15.0 mole %, 10.0 mole %, 8.0 mole %, 6.0 mole %, 5.0 mole %, 4.0 mole %, 3.0 mole %, 2.0 mole %, or 1.0 mole %, based on polymer units derived from the C₃ to C₂₀ olefin. Any of the lower limits may be combined with any of the upper limits to form a range. Comonomer content is based on the total content of all monomers in the polymer.

In a class of embodiments, the polyethylene polymer may have minimal long chain branching (i.e., less than 1.0 long-chain branch/1000 carbon atoms, preferably from 0.05 to 0.50 long-chain branch/1000 carbon atoms). Such values are characteristic of a linear structure that is consistent with a branching index (as defined below) of g′ᵥᵢₛ≥0.980, ≥0.985, ≥0.99, ≥0.995, or 1.0. While such values are indicative of little to no long chain branching, some long chain branches may be present (i.e., less than 1.0 long-chain branch/1000 carbon atoms, preferably less than 0.5 long-chain branch/1000 carbon atoms, more preferably 0.05 to 0.50 long-chain branch/1000 carbon atoms).

In some embodiments, the polyethylene polymers may have a density in accordance with ASTM D-4703 and ASTM D-1505/ISO 1183 of from about 0.910 to about 0.925 g/cm³, from about 0.910 to about 0.923 g/cm³, from about 0.910 to about 0.920 g/cm³, from about 0.915 to about 0.921 g/cm³, from about 0.910 to about 0.918 g/cm³, from about 0.912 to about 0.918 g/cm³, or from about 0.912 to 0.917 g/cm³.

The weight average molecular weight (M_{w}) of the polyethylene polymers may be from about 15,000 to about 500,000 g/mol, from about 20,000 to about 250,000 g/mol, from about 25,000 to about 150,000 g/mol, from about 150,000 to about 400,000 g/mol, from about 200,000 to about 400,000 g/mol, or from about 250,000 to about 350,000 g/mol.

The polyethylene polymers may have a molecular weight distribution (MWD) or (M_{w}/Mₙ) of from about 1.5 to about 5.0, from about 2.0 to about 4.0, from about 3.0 to about 4.0, or from about 2.5 to about 4.0.

The polyethylene polymers may have a z-average molecular weight (M_{z}) to weight average molecular weight (M_{w}) greater than about 1.5, or greater than about 1.7, or greater than about 2.0. In some embodiments, this ratio is from about 1.7 to about 3.5, from about 2.0 to about 3.0, or from about 2.2 to about 3.0.

The polyethylene polymers may have a melt index (MI) or (I_{2.16}) as measured by ASTM D-1238-E (190° C./2.16 kg) of about 0.1 to about 300 g/10 min, about 0.1 to about 100 g/10 min, about 0.1 to about 50 g/10 min, about 0.1 g/10 to about 5.0 g/10 min, about 0.1 g/10 to about 3.0 g/10 min, about 0.1 g/10 to about 2.0 g/10 min, about 0.1 g/10 to about 1.2 g/10 min, about 0.2 g/10 to about 1.5 g/10 min, about 0.2 g/10 to about 1.1 g/10 min, about 0.3 g/10 to about 1.0 g/10 min, about 0.4 g/10 to about 1.0 g/10 min, about 0.5 g/10 to about 1.0 g/10 min, about 0.6 g/10 to about 1.0 g/10 min, about 0.7 g/10 to about 1.0 g/10 min, or about 0.75 g/10 to about 0.95 g/10 min.

The polyethylene polymers may have a melt index ratio (MIR) (I_{21.6}/I_{2.16}) (as defined below) of from about 10.0 to about 50.0, from about 15.0 to about 45.0, from about 20.0 to about 40.0, from about 20.0 to about 35.0, from about 22 to about 38, from about 20 to about 32, from about 25 to about 31, or from about 28 to about 30.

In a class of embodiments, the polyethylene polymers may contain less than 5.0 ppm hafnium, less than 2.0 ppm hafnium, less than 1.5 ppm hafnium, or less than 1.0 ppm hafnium. In other embodiments, the polyethylene polymers may contain from about 0.01 ppm to about 2 ppm hafnium, from about 0.01 ppm to about 1.5 ppm hafnium, or from about 0.01 ppm to about 1.0 ppm hafnium.

Typically, the amount of hafnium is greater than the amount of zirconium in the polyethylene polymer. In a particular class of embodiments, the ratio of hafnium to zirconium (ppm/ppm) is at least about 2.0, at least about 10.0, at least about 15.0, at least about 17.0, at least about 20.0, at least about 25.0, at least about 50.0, at least about 100.0, at least about 200.0, or at least about 500.0 or more. While zirconium generally is present as an impurity in hafnium, it will be realized in some embodiments where particularly pure hafnium-containing catalysts are used, the amount of zirconium may be extremely low, resulting in an undetectable or a substantially undetectable amount of zirconium in the polyethylene polymer. Thus, the upper limit on the ratio of hafnium to zirconium in the polymer may be quite large.

In several classes of embodiments, the polyethylene polymers may have at least a first peak and a second peak in a comonomer distribution analysis, wherein the first peak has a maximum at a log(M_{w}) value of 4.0 to 5.4, 4.3 to 5.0, or 4.5 to 4.7; and a TREF elution temperature of 70.0° C. to 100.0° C., 80.0° C. to 95.0° C., or 85.0° C. to 90.0° C. The second peak in the comonomer distribution analysis has a maximum at a log(M_{w}) value of 5.0 to 6.0, 5.3 to 5.7, or 5.4 to 5.6; and a TREF elution temperature of 40.0° C. to 60.0° C., 45.0° C. to 60.0° C., or 48.0° C. to 54.0° C.

In any of the embodiments described above, the polyethylene polymer may have one or more of the following properties: a melt index (MI) (190° C./2.16 kg) of from about 0.1 g/10 min to about 5.0 g/10 min; a melt index ratio (MIR) of from about 15 to about 30; a M_{w} of from about 20,000 g/mol to about 200,000 g/mol; a M_{w}/Mₙ of from about 2.0 to about 4.5; and a density of from about 0.910 g/cm³ to about 0.925 g/cm³. In any of these embodiments, the amount of hafnium is greater than the amount of zirconium and a ratio of hafnium to zirconium (ppm/ppm) may be at least about 2.0, at least about 10.0, at least about 15.0, at least about 17.0, at least about 20.0, or at least about 25.0.

In several of the classes of embodiments described above, the polyethylene polymer may have a Broad Orthogonal Comonomer Distribution or “BOCD.” “BOCD” refers to a Broad Orthogonal Composition Distribution in which the comonomer of a copolymer is incorporated predominantly in the high molecular weight chains or species of a polyolefin polymer or composition. The distribution of the short chain branches can be measured, for example, using Temperature Raising Elution Fractionation (TREF) in connection with a Light Scattering (LS) detector to determine the weight average molecular weight of the molecules eluted from the TREF column at a given temperature. The combination of TREF and LS (TREF-LS) yields information about the breadth of the composition distribution and whether the comonomer content increases, decreases, or is uniform across the chains of different molecular weights of polymer chains. BOCD has been described, for example, in U.S. Pat. No. 8,378,043, Col. 3, line 34, bridging Col. 4, line 19; and U.S. Pat. No. 8,476,392, line 43, bridging Col. 16, line 54.

The TREF-LS data reported herein were measured using an analytical size TREF instrument (Polymerchar, Spain), with a column of the following dimension: inner diameter (ID) 7.8 mm; outer diameter (OD) 9.53 mm; and a column length of 150 mm. The column was filled with steel beads. 0.5 mL of a 6.4% (w/v) polymer solution in orthodichlorobenzene (ODCB) containing 6 g BHT/4 L were charged onto the column and cooled from 140° C. to 25° C. at a constant cooling rate of 1.0° C./min. Subsequently, the ODCB was pumped through the column at a flow rate of 1.0 ml/min and the column temperature was increased at a constant heating rate of 2° C./min to elute the polymer. The polymer concentration in the eluted liquid was detected by means of measuring the absorption at a wavenumber of 2857 cm⁻¹ using an infrared detector. The concentration of the ethylene-α-olefin copolymer in the eluted liquid was calculated from the absorption and plotted as a function of temperature. The molecular weight of the ethylene-α-olefin copolymer in the eluted liquid was measured by light scattering using a Minidawn Tristar light scattering detector (Wyatt, Calif, USA). The molecular weight was also plotted as a function of temperature.

The breadth of the composition distribution is characterized by the T₇₅−T₂₅ value, wherein T₂₅ is the temperature at which 25% of the eluted polymer is obtained and T₇₅ is the temperature at which 75% of the eluted polymer is obtained in a TREF experiment as described herein. The composition distribution is further characterized by the F₈₀ value, which is the fraction of polymer that elutes below 80° C. in a TREF-LS experiment, as described herein. A higher F₈₀ value indicates a higher fraction of comonomer in the polymer molecule. An orthogonal composition distribution is defined by a M₆₀/M₉₀ value that is greater than 1, wherein M₆₀ is the molecular weight of the polymer fraction that elutes at 60° C. in a TREF-LS experiment and M₉₀ is the molecular weight of the polymer fraction that elutes at 90° C. in a TREF-LS experiment, as described herein.

In a class of embodiments, the polymers, as described herein, may have a BOCD characterized in that the T₇₅−T₂₅ value is 1 or greater, 2.0 or greater, 2.5 or greater, 4.0 or greater, 5.0 or greater, 7.0 or greater, 10.0 or greater, 11.5 or greater, 15.0 or greater, 17.5 or greater, 20.0 or greater, or 25.0 or greater, wherein T₂₅ is the temperature at which 25% of the eluted polymer is obtained and T₇₅ is the temperature at which 75% of the eluted polymer is obtained in a TREF experiment as described herein.

The polymers as described herein may further have a BOCD characterized in that M₆₀/M₉₀ value is 1.5 or greater, 2.0 or greater, 2.25 or greater, 2.50 or greater, 3.0 or greater, 3.5 or greater, 4.0 or greater, 4.5 or greater, or 5.0 or greater, wherein M₆₀ is the molecular weight of the polymer fraction that elutes at 60° C. in a TREF-LS experiment and M₉₀ is the molecular weight of the polymer fraction that elutes at 90° C. in a TREF-LS experiment, as described herein.

Additionally, the polymers, as described herein, may further have a BOCD characterized in that F₈₀ value is 1% or greater, 2% or greater, 3% or greater, 4% or greater, 5% or greater, 6% or greater, 7% or greater, 10% or greater, 11% or greater, 12% or greater, or 15% or greater, wherein F₈₀ is the fraction of polymer that elutes below 80° C.

Additionally, the melt strength of the polyethylene polymer at a particular temperature may be determined with a Gottfert Rheotens Melt Strength Apparatus. To determine the melt strength, unless otherwise stated, a polymer melt strand extruded from the capillary die is gripped between two counter-rotating wheels on the apparatus. The take-up speed is increased at a constant acceleration of 2.4 mm/sec². The maximum pulling force (in the unit of cN) achieved before the strand breaks or starts to show draw-resonance is determined as the melt strength. The temperature of the rheometer is set at 190° C. The capillary die has a length of 30 mm and a diameter of 2 mm. The polymer melt is extruded from the die at a speed of 10 mm/sec. The distance between the die exit and the wheel contact point should be 122 mm.

The melt strength of the polyethylene polymer may be in the range from about 1 to about 100 cN, about 1 to about 50 cN, about 1 to about 25 cN, about 3 to about 15 cN, about 4 to about 12 cN, or about 5 to about 10 cN.

Materials and processes for making the polyethylene polymer have been described in, for example, U.S. Pat. No. 6,956,088, particularly Example 1; U.S. Publication No. 2009/0297810, particularly Example 1; U.S. Publication No. 2015/0291748, particularly PE1-PE5 in the Examples; and WO 2014/099356, particularly PE3 referenced on page 12 and in the Examples, including the use of a silica supported hafnium transition metal metallocene/methylalumoxane catalyst system described in, for example, U.S. Pat. Nos. 6,242,545; and 6,248,845, particularly Example 1.

The polyethylene polymer is commercially available from ExxonMobil Chemical Company, Houston, Tex., and sold under EXCEED XP™ Performance Polymer. EXCEED XP™ Performance Polymer offers step-out performance with respect to, for example, dart drop impact strength, flex-crack resistance, and machine direction (MD) tear, as well as maintaining stiffness at lower densities. EXCEED XP™ mPE also offers optimized solutions for a good balance of melt strength, toughness, stiffness, and sealing capabilities which makes this family of polymers well-suited for blown film/cast film solutions.

### Additional Polymers

Additional polymers may be combined with the polyethylene polymer described above in a blend in a cast film, for example, in one or more layers in a multilayer cast film or structure. The additional polymers may include other polyolefin polymers such as the following ethylene-based and/or propylene-based polymers.

### First Additional Polyethylene Polymer

The first additional polyethylene polymers are ethylene-based polymers having about 99.0 wt % to about 80.0 wt %, about 99.0 wt % to about 85.0 wt %, about 99.0 wt % to about 87.5 wt %, about 99.0 wt % to about 90.0 wt %, about 99.0 wt % to about 92.5 wt %, about 99.0 wt % to about 95.0 wt %, or about 99.0 wt % to about 97.0 wt %, of polymer units derived from ethylene and about 1.0 wt % to about 20.0 wt %, about 1.0 wt % to about 15.0 wt %, about 1.0 wt % to about 12.5 wt %, about 1.0 wt % to about 10.0 wt %, about 1.0 wt % to about 7.5 wt %, about 1.0 wt % to about 5.0 wt %, or about 1.0 wt % to about 3.0 wt %, of polymer units derived from one or more C₃ to C₂₀ α-olefin comonomers, preferably C₃ to C₁₀ α-olefins, and more preferably C₄ to C₈ α-olefins. The α-olefin comonomer may be linear, branched, cyclic and/or substituted, and two or more comonomers may be used, if desired. Examples of suitable comonomers include propylene, butene, 1-pentene; 1-pentene with one or more methyl, ethyl, or propyl substituents; 1-hexene; 1-hexene with one or more methyl, ethyl, or propyl substituents; 1-heptene; 1-heptene with one or more methyl, ethyl, or propyl substituents; 1-octene; 1-octene with one or more methyl, ethyl, or propyl substituents; 1-nonene; 1-nonene with one or more methyl, ethyl, or propyl substituents; ethyl, methyl, or dimethyl-substituted 1-decene; 1-dodecene; and styrene. Particularly suitable comonomers include 1-butene, 1-hexene, and 1-octene, 1-hexene, and mixtures thereof.

In an embodiment of the invention, the first additional polyethylene polymer comprises from about 8 wt % to about 15 wt %, of C₃-C₁₀ α-olefin derived units, and from about 92 wt % to about 85 wt % ethylene derived units, based upon the total weight of the polymer.

In another embodiment of the invention, the first additional polyethylene polymer comprises from about 9 wt % to about 12 wt %, of C₃-C₁₀ α-olefin derived units, and from about 91 wt % to about 88 wt % ethylene derived units, based upon the total weight of the polymer.

The first additional polyethylene polymers may have a melt index (MI), 12.16 or simply 12 for shorthand according to ASTM D1238, condition E (190° C./2.16 kg) reported in grams per 10 minutes (g/10 min), of ≥about 0.10 g/10 min, e.g., ≥about 0.15 g/10 min, ≥about 0.18 g/10 min, ≥about 0.20 g/10 min, ≥about 0.22 g/10 min, ≥about 0.25 g/10 min, ≥about 0.28, or ≥about 0.30 g/10 min. Additionally, the first additional polyethylene polymers may have a melt index (I_{2.16})≤about 3.0 g/10 min, ≤about 2.0 g/10 min, ≤about 1.5 g/10 min, ≤about 1.0 g/10 min, ≤about 0.75 g/10 min, ≤about 0.50 g/10 min, ≤about 0.40 g/10 min, ≤about 0.30 g/10 min, ≤about 0.25 g/10 min, ≤about 0.22 g/10 min, ≤about 0.20 g/10 min, ≤about 0.18 g/10 min, or ≤about 0.15 g/10 min. Ranges expressly disclosed include, but are not limited to, ranges formed by combinations any of the above-enumerated values, e.g., from about 0.1 to about 3.0, about 0.2 to about 2.0, about 0.2 to about 0.5 g/10 min, etc.

The first additional polyethylene polymers may also have High Load Melt Index (HLMI), I_{21.6} or I₂₁ for shorthand, measured in accordance with ASTM D-1238, condition F (190° C./21.6 kg). For a given polymer having an MI and MIR as defined herein, the HLMI is fixed and can be calculated in accordance with the following paragraph.

The first additional polyethylene polymers may have a Melt Index Ratio (MIR) which is a dimensionless number and is the ratio of the high load melt index to the melt index, or I_{21.6}/I_{2.16} as described above. The MIR of the first additional polyethylene polymers may be from 25 to 80, alternatively, from 25 to 60, alternatively, from about 30 to about 55, and alternatively, from about 35 to about 50.

The first additional polyethylene polymers may have a density ≥about 0.905 g/cm³, ≥about 0.910 g/cm³, ≥about 0.912 g/cm³, ≥about 0.913 g/cm³, ≥about 0.915 g/cm³, ≥about 0.916 g/cm³, ≥about 0.917 g/cm³, ≥about 0.918 g/cm³. Additionally or alternatively, first additional polyethylene polymers may have a density ≤about 0.945 g/cm³, e.g., ≤about 0.940 g/cm³, ≤about 0.937 g/cm³, ≤about 0.935 g/cm³, ≤about 0.930 g/cm³, ≤about 0.925 g/cm³, ≤about 0.920 g/cm³, or ≤about 0.918 g/cm³. Ranges expressly disclosed include, but are not limited to, ranges formed by combinations any of the above-enumerated values, e.g., from about 0.905 to about 0.945 g/cm³, 0.910 to about 0.935 g/cm³, 0.912 to 0.930 g/cm³, 0.916 to 0.925 g/cm³, 0.918 to 0.920 g/cm³, etc. Density is determined using chips cut from plaques compression molded in accordance with ASTM D-1928 Procedure C, aged in accordance with ASTM D-618 Procedure A, and measured as specified by ASTM D-1505.

Typically, although not necessarily, the first additional polyethylene polymers may have a molecular weight distribution (MWD, defined as M_{w}/Mₙ) of about 2.5 to about 5.5, preferably 3.0 to 4.0.

The melt strength may be in the range from about 1 to about 100 cN, about 1 to about 50 cN, about 1 to about 25 cN, about 3 to about 15 cN, about 4 to about 12 cN, or about 5 to about 10 cN.

The first additional polyethylene polymers (or cast films made therefrom) may also be characterized by an averaged 1% secant modulus (M) of from 10,000 to 60,000 psi (pounds per square inch), alternatively, from 20,000 to 40,000 psi, alternatively, from 20,000 to 35,000 psi, alternatively, from 25,000 to 35,000 psi, and alternatively, from 28,000 to 33,000 psi, and a relation between M and the dart drop impact strength in g/mil (DIS) complying with formula (A):

DIS≥0.8*[100+e^{(11.71-0.000268M+2.183×10}^{^{−9}}^{M}^{²}⁾] (A),

where “e” represents 2.7183, the base Napierian logarithm, M is the averaged modulus in psi, and DIS is the 26 inch dart impact strength. The DIS is preferably from about 120 to about 1000 g/mil, even more preferably, from about 150 to about 800 g/mil.

The branching index, g′ is inversely proportional to the amount of branching. Thus, lower values for g′ indicate relatively higher amounts of branching. The amounts of short and long-chain branching each contribute to the branching index according to the formula: g′=g′_{LCB}×g′_{SCB}.

Typically, the first additional polyethylene polymers have a g′vis of 0.85 to 0.99, particularly, 0.87 to 0.97, 0.89 to 0.97, 0.91 to 0.97, 0.93 to 0.95, or 0.97 to 0.99.

The first additional polyethylene polymers may be made by any suitable polymerization method including solution polymerization, slurry polymerization, supercritical, and gas phase polymerization using supported or unsupported catalyst systems, such as a system incorporating a metallocene catalyst.

As used herein, the term “metallocene catalyst” is defined to comprise at least one transition metal compound containing one or more substituted or unsubstituted cyclopentadienyl moiety (Cp) (typically two Cp moieties) in combination with a Group 4, 5, or 6 transition metal, such as, zirconium, hafnium, and titanium.

Metallocene catalysts generally require activation with a suitable co-catalyst, or activator, in order to yield an “active metallocene catalyst”, i.e., an organometallic complex with a vacant coordination site that can coordinate, insert, and polymerize olefins. Active catalyst systems generally include not only the metallocene complex, but also an activator, such as an alumoxane or a derivative thereof (preferably methyl alumoxane), an ionizing activator, a Lewis acid, or a combination thereof. Alkylalumoxanes (typically methyl alumoxane and modified methylalumoxanes) are particularly suitable as catalyst activators. The catalyst system may be supported on a carrier, typically an inorganic oxide or chloride or a resinous material such as, for example, polyethylene or silica.

Zirconium transition metal metallocene-type catalyst systems are particularly suitable. Non-limiting examples of metallocene catalysts and catalyst systems useful in practicing the present invention include those described in, U.S. Pat. Nos. 5,466,649; 6,476,171; 6,225,426; and 7,951,873, and in the references cited therein, all of which are fully incorporated herein by reference. Particularly useful catalyst systems include supported dimethylsilyl bis(tetrahydroindenyl) zirconium dichloride.

Supported polymerization catalyst may be deposited on, bonded to, contacted with, or incorporated within, adsorbed or absorbed in, or on, a support or carrier. In another embodiment, the metallocene is introduced onto a support by slurrying a presupported activator in oil, a hydrocarbon such as pentane, solvent, or non-solvent, then adding the metallocene as a solid while stirring. The metallocene may be finely divided solids. Although the metallocene is typically of very low solubility in the diluting medium, it is found to distribute onto the support and be active for polymerization. Very low solubilizing media such as mineral oil (e.g., Kaydo™ or Drakol™) or pentane may be used. The diluent can be filtered off and the remaining solid shows polymerization capability much as would be expected if the catalyst had been prepared by traditional methods such as contacting the catalyst with methylalumoxane in toluene, contacting with the support, followed by removal of the solvent. If the diluent is volatile, such as pentane, it may be removed under vacuum or by nitrogen purge to afford an active catalyst. The mixing time may be greater than 4 hours, but shorter times are suitable.

Typically in a gas phase polymerization process, a continuous cycle is employed where in one part of the cycle of a reactor, a cycling gas stream, otherwise known as a recycle stream or fluidizing medium, is heated in the reactor by the heat of polymerization. This heat is removed in another part of the cycle by a cooling system external to the reactor. (See e.g., U.S. Pat. Nos. 4,543,399; 4,588,790; 5,028,670; 5,317,036; 5,352,749; 5,405,922; 5,436,304; 5,453,471; 5,462,999; 5,616,661; and 5,668,228.) To obtain the first additional polyethylene polymers, individual flow rates of ethylene, comonomer, and hydrogen should be controlled and adjusted to obtain the desired polymer properties.

Suitable commercial polymers for the first additional polyethylene polymer are available from ExxonMobil Chemical Company as Enable™ metallocene polyethylene (mPE) resins.

### Second Additional Polyethylene Polymer

The second additional polyethylene polymers are ethylene-based polymers comprising ≥50.0 wt % of polymer units derived from ethylene and ≤50.0 wt % preferably 1.0 wt % to 35.0 wt %, even more preferably 1 wt % to 6 wt % of polymer units derived from a C₃ to C₂₀ alpha-olefin comonomer (for example, hexene or octene).

The second additional polyethylene polymer may have a density of ≥about 0.910 g/cm³, ≥about 0.915 g/cm³, ≥about 0.920 g/cm³, ≥about 0.925 g/cm³, ≥about 0.930 g/cm³, or ≥about 0.940 g/cm³. Alternatively, the second polyethylene polymer may have a density of ≤about 0.950 g/cm³, e.g., ≤about 0.940 g/cm³, ≤about 0.930 g/cm³, ≤about 0.925 g/cm³, ≤about 0.920 g/cm³, or ≤about 0.915 g/cm³. Ranges expressly disclosed include ranges formed by combinations of any of the above-enumerated values, e.g., 0.910 to 0.950 g/cm³, 0.910 to 0.930 g/cm³, 0.910 to 0.925 g/cm³, etc. Density is determined using chips cut from plaques compression molded in accordance with ASTM D-1928 Procedure C, aged in accordance with ASTM D-618 Procedure A, and measured as specified by ASTM D-1505.

The second additional polyethylene polymer may have a melt index (I_{2.16}) according to ASTM D1238 (190° C./2.16 kg) of ≥about 0.5 g/10 min., e.g., ≥about 0.5 g/10 min., ≥about 0.7 g/10 min., ≥about 0.9 g/10 min., ≥about 1.1 g/10 min., ≥about 1.3 g/10 min., ≥about 1.5 g/10 min., or ≥about 1.8 g/10 min. Alternatively, the melt index (I_{2.16}) may be ≤about 8.0 g/10 min., ≤about 7.5 g/10 min., ≤about 5.0 g/10 min., ≤about 4.5 g/10 min., ≤about 3.5 g/10 min., ≤about 3.0 g/10 min., ≤about 2.0 g/10 min., e.g., ≤about 1.8 g/10 min., ≤about 1.5 g/10 min., ≤about 1.3 g/10 min., ≤about 1.1 g/10 min., ≤about 0.9 g/10 min., or ≤about 0.7 g/10 min., about 0.5 to 2.0 g/10 min., particularly about 0.75 to 1.5 g/10 min. Ranges expressly disclosed include ranges formed by combinations of any of the above-enumerated values, e.g., about 0.5 to about 8.0 g/10 min., about 0.7 to about 1.8 g/10 min., about 0.9 to about 1.5 g/10 min., about 0.9 to about 1.3 g/10 min., about 0.9 to about 1.1 g/10 min, about 1.0 g/10 min., etc.

In particular embodiments, the second additional polyethylene polymer may have a density of 0.910 to 0.920 g/cm³, a melt index (I_{2.16}) of 0.5 to 8.0 g/10 min., and a CDBI of 60.0% to 80.0%, preferably between 65% and 80%.

The second polyethylene polymers are generally considered linear. Suitable second additional polyethylene polymers are available from ExxonMobil Chemical Company under the trade name EXCEED™ metallocene (mPE) resins. The MIR for EXCEED™ materials will typically be from about 15 to about 20.

### Third Additional Polyethylene Polymer

The third additional polyethylene polymers may be a copolymer of ethylene, and one or more polar comonomers or C₃ to C₁₀ α-olefins. Typically, the third additional polyethylene polymer includes about 99.0 wt % to about 80.0 wt %, about 99.0 wt % to about 85.0 wt %, about 99.0 wt % to about 87.5 wt %, about 95.0 wt % to about 90.0 wt %, of polymer units derived from ethylene and about 1.0 wt % to about 20.0 wt %, about 1.0 wt % to about 15.0 wt %, about 1.0 wt % about to about 12.5 wt %, or about 5.0 wt % to about 10.0 wt % of polymer units derived from one or more polar comonomers, based upon the total weight of the polymer. Suitable polar comonomers include, but are not limited to: vinyl ethers, such as, vinyl methyl ether, vinyl n-butyl ether, vinyl phenyl ether, vinyl beta-hydroxy-ethyl ether, and vinyl dimethylamino-ethyl ether; olefins, such as, propylene, butene-1, cis-butene-2, trans-butene-2, isobutylene, 3,3,-dimethylbutene-1,4-methylpentene-1, octene-1, and styrene; vinyl type esters, such as, vinyl acetate, vinyl butyrate, vinyl pivalate, and vinylene carbonate; haloolefins, such as, vinyl fluoride, vinylidene fluoride, tetrafluoroethylene, vinyl chloride, vinylidene chloride, tetrachloroethylene, and chlorotrifluoroethylene; acrylic-type esters, such as, methyl acrylate, ethyl acrylate, n-butyl acrylate, t-butyl acrylate, 2-ethylhexyl acrylate, alpha-cyanoisopropyl acrylate, beta-cyanoethyl acrylate, o-(3-phenylpropan-1,3,-dionyl)phenyl acrylate, methyl methacrylate, n-butyl methacrylate, t-butyl methacrylate, cyclohexyl methacrylate, 2-ethylhexyl methacrylate, methyl methacrylate, glycidyl methacrylate, beta-hydroxethyl methacrylate, beta-hydroxpropyl methacrylate, 3-hydroxy-4-carbo-methoxy-phenyl methacrylate, N,N-dimethylaminoethyl methacrylate, t-butylaminoethyl methacrylate, 2-(1-aziridinyl)ethyl methacrylate, diethyl fumarate, diethyl maleate, and methyl crotonate; other acrylic-type derivatives, such as, acrylic acid, methacrylic acid, crotonic acid, maleic acid, methyl hydroxy maleate, itaconic acid, acrylonitrile, fumaronitrile, N,N-dimethylacrylamide, N-isopropylacrylamide, N-t-butylacrylamide, N-phenylacrylamide, diacetone acrylamide, methacrylamide, N-phenylmethacrylamide, N-ethylmaleimide, and maleic anhydride; and other compounds, such as, allyl alcohol, vinyltrimethylsilane, vinyltriethoxysilane, N-vinylcarbazole, N-vinyl-N-methylacetamide, vinyldibutylphosphine oxide, vinyldiphenylphosphine oxide, bis-(2-chloroethyl) vinylphosphonate, and vinyl methyl sulfide.

In some embodiments, the third additional polyethylene polymer is an ethylene/vinyl acetate copolymer having about 2.0 wt % to about 15.0 wt %, typically about 5.0 wt % to about 10.0 wt %, polymer units derived from vinyl acetate, based on the amounts of polymer units derived from ethylene and vinyl acetate (EVA). In certain embodiments, the EVA resin can further include polymer units derived from one or more comonomer units selected from propylene, butene, 1-hexene, 1-octene, and/or one or more dienes.

Suitable dienes include, for example, 1,4-hexadiene, 1,6-octadiene, 5-methyl-1,4-hexadiene, 3,7-dimethyl-1,6-octadiene, dicyclopentadiene (DCPD), ethylidene norbornene (ENB), norbornadiene, 5-vinyl-2-norbornene (VNB), and combinations thereof.

Suitable third additional polyethylene polymers include Escorene™ Ultra EVA resins, Escor™ EAA resins, ExxonMobil™ EnBA resins, and Optema™ EMA resins available from ExxonMobil Chemical Company, Houston, Tex.

### Fourth Additional Polyethylene Polymer

The fourth additional polyethylene polymers are generally heterogeneously branched ethylene polymers. The term “heterogeneously branched ethylene polymer” refers to a polymer having polymer units derived from ethylene and preferably at least one C₃-C₂₀ alpha-olefin and having a CDBI<50.0%. Typically, such polymers are the result of a Ziegler-Natta polymerization process. Such polymers are also referred to as Linear Low Density Polyethylene Polymers or LLDPEs, more particularly sometimes as ZN LLDPEs.

Heterogeneously branched ethylene polymers differ from the homogeneously branched ethylene polymers primarily in their branching distribution. For example, heterogeneously branched LLDPE polymers have a distribution of branching, including a highly branched portion (similar to a very low density polyethylene), a medium branched portion (similar to a medium branched polyethylene) and an essentially linear portion (similar to linear homopolymer polyethylene). The amount of each of these fractions varies depending upon the whole polymer properties desired. For example, a linear homopolymer polyethylene polymer has neither branched nor highly branched fractions, but is linear.

Heterogeneously branched ethylene polymer polymers typically have a CDBI<50.0%, preferably <45.0%, <40.0%, <35.0%, <30.0%, <25.0%, or <20.0%. In particular embodiments, the CDBI of the heterogeneously branched ethylene polymer is 20.0 to <50.0%, 20.0 to 45.0%, 20.0 to 35.0%, 20.0 to 30.0%, 20.0 to 25.0%, 25.0 to 30.0%, 25.0 to 35.0%, 25.0 to 40.0%, 25.0 to 45.0%, 30.0 to 35.0%, 30.0 to 40.0%, 30.0 to 45.0%, 30.0 to <50.0%, 35.0 to 40.0%, 35.0 to <50.0%, 40.0 to 45.0%, or 40.0 to <50.0%.

The heterogeneously branched ethylene polymer typically comprises 80 to 100 mole % of polymer units derived from ethylene and 0 to 20.0 mole % of polymer units derived from at least one C₃ to C₂₀ alpha-olefin, preferably the alpha olefin has 4 to 8 carbon atoms. The content of comonomer is determined based on the mole fraction based on the content of all monomers in the polymer.

The content of polymer units derived from alpha-olefin in the heterogeneously branched ethylene polymer may be any amount consistent with the above ranges for ethylene. Some preferred amounts are 2.0 to 20.0 mole %, 2.0 to 15.0 mole %, or 5.0 to 10.0 mole %, particularly where the polymer units are derived from one or more C₄-C₈ alpha-olefins, more particularly butene-1, hexene-1, or octene-1.

Heterogeneously branched ethylene polymers may have a density ≤0.950 g/cm³, preferably ≤0.940 g/cm³, particularly from about 0.915 to about 0.950 g/cm³, preferably about 0.920 to about 0.940 g/cm³.

The melt index, 12.16, according to ASTM D-1238-E (190° C./2.16 kg) of the heterogeneously branched ethylene polymer is generally from about 0.1 g/10 min. to about 100.0 g/10 min.

Suitable heterogeneously branched ethylene polymers and other polyethylene polymers include ExxonMobil™ Linear Low Density Polyethylene (LLDPE) and ExxonMobil™ NTX Super hexene copolymer available from ExxonMobil Chemical Company, Houston, Tex.

A fifth additional polyethylene polymer may also be present as High Density Polyethylene (HDPE). The HDPE may be unimodal or bimodal/multimodal and have a narrow molecular weight distribution (MWD) or broad MWD.

A sixth additional polyethylene polymer may also be present as Low Density Polyethylene made from a High Pressure Polymerization Process. Suitable resins include Nexxstar™ resins available from ExxonMobil and other LDPE's.

### Propylene-Based Polymer

Propylene-based polymers are also contemplated. A suitable propylene-based polymer or elastomer (“PBE”) comprises propylene and from about 5 wt % to about 25 wt % of one or more comonomers selected from ethylene and/or C₄-C₁₂ α-olefins. In one or more embodiments, the α-olefin comonomer units may be derived from ethylene, butene, pentene, hexene, 4-methyl-1-pentene, octene, or decene. The embodiments described below are discussed with reference to ethylene as the α-olefin comonomer, but the embodiments are equally applicable to other copolymers with other α-olefin comonomers. In this regard, the copolymers may simply be referred to as propylene-based polymers with reference to ethylene as the α-olefin.

In one or more embodiments, the PBE may include at least about 2 wt %, at least about 3 wt %, at least about 4 wt %, at least about 5 wt %, at least about 6 wt %, at least about 7 wt %, or at least about 8 wt %, or at least about 9 wt %, or at least about 10 wt %, or at least about 12 wt % ethylene-derived units. In those or other embodiments, the PBE may include up to about 30 wt %, or up to about 25 wt %, or up to about 22 wt %, or up to about 20 wt %, or up to about 19 wt %, or up to about 18 wt %, or up to about 17 wt % ethylene-derived units, where the percentage by weight is based upon the total weight of the propylene-derived and α-olefin derived units. Stated another way, the PBE may include at least about 70 wt %, or at least about 75 wt %, or at least about 80 wt %, or at least about 81 wt % propylene-derived units, or at least about 82 wt % propylene-derived units, or at least about 83 wt % propylene-derived units; and in these or other embodiments, the PBE may include up to about 95 wt %, or up to about 94 wt %, or up to about 93 wt %, or up to about 92 wt %, or up to about 90 wt %, or up to about 88 wt % propylene-derived units, where the percentage by weight is based upon the total weight of the propylene-derived and α-olefin derived units. In certain embodiments, the PBE may comprise from about 5 wt % to about 25 wt % ethylene-derived units, or from about 9 wt % to about 18 wt % ethylene-derived units.

The PBEs of one or more embodiments are characterized by a melting point (Tm), which can be determined by differential scanning calorimetry (DSC). For purposes herein, the maximum of the highest temperature peak is considered to be the melting point of the polymer. A “peak” in this context is defined as a change in the general slope of the DSC curve (heat flow versus temperature) from positive to negative, forming a maximum without a shift in the baseline where the DSC curve is plotted so that an endothermic reaction would be shown with a positive peak.

In one or more embodiments, the Tm of the PBE (as determined by DSC) is less than about 115° C., or less than about 110° C., or less than about 100° C., or less than about 95° C., or less than about 90° C.

In one or more embodiments, the PBE may be characterized by its heat of fusion (Hf), as determined by DSC. In one or more embodiments, the PBE may have an Hf that is at least about 0.5 J/g, or at least about 1.0 J/g, or at least about 1.5 J/g, or at least about 3.0 J/g, or at least about 4.0 J/g, or at least about 5.0 J/g, or at least about 6.0 J/g, or at least about 7.0 J/g. In these or other embodiments, the PBE may be characterized by an Hf of less than about 75 J/g, or less than about 70 J/g, or less than about 60 J/g, or less than about 50 J/g, or less than about 45 J/g, or less than about 40 J/g, or less than about 35 J/g, or less than about 30 J/g.

As used within this specification, DSC procedures for determining Tm and Hf include the following. The polymer is pressed at a temperature of from about 200° C. to about 230° C. in a heated press, and the resulting polymer cast film is hung, at about 23° C., in the air to cool. About 6 to 10 mg of the polymer cast film is removed with a punch die. This 6 to 10 mg sample is annealed at about 23° C. for about 80 to 100 hrs. At the end of this period, the sample is placed in a DSC (Perkin Elmer Pyris One Thermal Analysis System) and cooled at a rate of about 10° C./min to about −50° C. to about −70° C. The sample is heated at a rate of about 10° C./min to attain a final temperature of about 200° C. The sample is kept at 200° C. for 5 minutes and a second cool-heat cycle is performed. Events from both cycles are recorded. The thermal output is recorded as the area under the melting peak of the sample, which typically occurs between about 0° C. and about 200° C. It is measured in Joules and is a measure of the Hf of the polymer.

The PBE can have a triad tacticity of three propylene units, as measured by ¹³C NMR, of 75% or greater, 80% or greater, 85% or greater, 90% or greater, 92% or greater, 95% or greater, or 97% or greater. In one or more embodiments, the triad tacticity may range from about 75 to about 99%, or from about 80 to about 99%, or from about 85 to about 99%, or from about 90 to about 99%, or from about 90 to about 97%, or from about 80 to about 97%. Triad tacticity is determined by the methods described in U.S. Pat. No. 7,232,871.

The PBE may have a tacticity index ranging from a lower limit of 4 or 6 to an upper limit of 8 or 10 or 12. The tacticity index, expressed herein as “m/r”, is determined by ¹³C nuclear magnetic resonance (“NMR”). The tacticity index, m/r, is calculated as defined by H. N. Cheng in 17 MACROMOLECULES 1950 (1984). The designation “m” or “r” describes the stereochemistry of pairs of contiguous propylene groups, “m” referring to meso and “r” to racemic. An m/r ratio of 1.0 generally describes a syndiotactic polymer, and an m/r ratio of 2.0 an atactic material. An isotactic material theoretically may have a ratio approaching infinity, and many by-product atactic polymers have sufficient isotactic content to result in ratios of greater than 50.

In one or more embodiments, the PBE may have a % crystallinity of from about 0.5% to about 40%, or from about 1% to about 30%, or from about 5% to about 25%, determined according to DSC procedures. Crystallinity may be determined by dividing the Hf of a sample by the Hf of a 100% crystalline polymer, which is assumed to be 189 J/g for isotactic polypropylene or 350 J/g for polyethylene.

In one or more embodiments, the PBE may have a density of from about 0.85 g/cm³ to about 0.92 g/cm³, or from about 0.86 g/cm³ to about 0.90 g/cm³, or from about 0.86 g/cm³ to about 0.89 g/cm³ at room temperature, as measured per the ASTM D-792.

In one or more embodiments, the PBE can have a melt index (MI) (ASTM D-1238-E, 2.16 kg @ 190° C.), of less than or equal to about 100 g/10 min, or less than or equal to about 50 g/10 min, or less than or equal to about 25 g/10 min, or less than or equal to about 10 g/10 min, or less than or equal to about 9.0 g/10 min, or less than or equal to about 8.0 g/10 min, or less than or equal to about 7.0 g/10 min.

In one or more embodiments, the PBE may have a melt flow rate (MFR), as measured according to ASTM D-1238-E (2.16 kg weight @ 230° C.), greater than about 1 g/10 min, or greater than about 2 g/10 min, or greater than about 5 g/10 min, or greater than about 8 g/10 min, or greater than about 10 g/10 min. In the same or other embodiments, the PBE may have an MFR less than about 500 g/10 min, or less than about 400 g/10 min, or less than about 300 g/10 min, or less than about 200 g/10 min, or less than about 100 g/10 min, or less than about 75 g/10 min, or less than about 50 g/10 min. In certain embodiments, the PBE may have an MFR from about 1 to about 100 g/10 min, or from about 2 to about 75 g/10 min, or from about 5 to about 50 g/10 min.

Suitable commercially available propylene-based polymers include Vistamaxx™ Performance Polymers from ExxonMobil Chemical Company and Versify™ Polymers from The Dow Chemical Company, Midland, Mich.

The propylene-based polymers may also include polypropylene homopolymers and/or other polypropylene copolymers. For these types of polymers, the term propylene-based polymer refers to a homopolymer, copolymer, or impact copolymer including >50.0 mole % of polymer units derived from propylene. Some useful propylene-based polymers include those having one or more of the following properties:

1) propylene content of at least 85 wt % (preferably at least 90 wt %, preferably at least 95 wt %, preferably at least 97 wt %, preferably 100 wt %);
2) M_{w} of 30 to 2,000 kg/mol (preferably 50 to 1,000 kg/mol, preferably 90 to 500 kg/mol);
3) M_{w}/Mₙ of 1 to 40 (preferably 1.4 to 20, preferably 1.6 to 10, preferably 1.8 to 3.5, preferably 1.8 to 2.5);
4) branching index (g′) of 0.2 to 2.0 (preferably 0.5 to 1.5, preferably 0.7 to 1.3, preferably 0.9 to 1.1);
5) melt flow rate (MFR) of 1 to 300 dg/min (preferably 5 to 150 dg/min, preferably 10 to 100 dg/min, preferably 20 to 60 dg/min);
6) melting point of at least 100° C. (preferably at least 110° C., preferably at least 120° C., preferably at least 130° C., preferably at least 140° C., preferably at least 150° C., preferably at least 160° C., preferably at least 165° C.);
7) crystallization temperature (T_{c}, peak) of at least 70° C. (preferably at least 90° C., preferably at least 110° C., preferably at least 130° C.);
8) heat of fusion (Hf) of 40 to 160 J/g (preferably 50 to 140 J/g, preferably 60 to 120 J/g, preferably 80 to 100 J/g);
9) crystallinity of 5 to 80% (preferably 10 to 75%, preferably 20 to 70%, preferably 30 to 65%, preferably 40 to 60%);
10) propylene meso diads of 90% or more (preferably 92% or more, preferably 94% or more, preferably 96% or more);
11) heat deflection temperature (HDT) of 45 to 140° C. (preferably 60 to 135° C., preferably 75 to 125° C.);
12) Gardner impact strength at 23° C. of 30 to 1300 J (preferably 40 to 800 J, preferably 50 to 600 J); and/or
13) flexural modulus of 300 to 3000 MPa (preferably 600 to 2500 MPa, preferably 800 to 2000 MPa, preferably 1000 to 1500 MPa).

In a class of embodiments, the propylene-based polymer is selected from polypropylene homopolymers, polypropylene copolymers, and blends or mixtures thereof. The homopolymer may be atactic polypropylene, isotactic polypropylene, highly isotactic polypropylene, syndiotactic polypropylene, and blends or mixtures thereof. The copolymer may be a random copolymer, a statistical copolymer, a block copolymer, and blends or mixtures thereof.

The method of making the propylene-based polymers is not critical, as they may be made by slurry, solution, gas-phase, high-pressure, or other suitable processes, through the use of catalyst systems appropriate for the polymerization of polyolefins, such as Ziegler-Natta-type catalysts, metallocene-type catalysts, other appropriate catalyst systems, or combinations thereof.

In a preferred embodiment, the propylene-based polymers are made by the catalysts, activators and processes described in U.S. Pat. Nos. 6,342,566; 6,384,142; 5,741,563; and PCT Publications WO 03/040201 and WO 97/19991. Such catalysts are well known in the art, and are described in, for example, ZIEGLER CATALYSTS (Gerhard Fink, Rolf Mülhaunt and Hans H. Brintzinger, eds., Springer-Verlag 1995); Resconi et al., Selectivity in Propene Polymerization with Metallocene Catalysts, 100 CHEM. REV., pp. 1253-1345 (2000); and I, II METALLOCENE-BASED POLYOLEFINS (Wiley & Sons, 2000).

Suitable propylene-based polymers include Achieve™ resins, ExxonMobil™ Polypropylene resins, and Exxtral™ Performance Polyolefins available from ExxonMobil Chemical Company, Houston, Tex.

### Polymer Blends

The cast films may include monolayer and multilayer cast films made from blends of the polymers described above or multilayer cast films of two or more layers comprising a “neat” polymer or a blend of the polymers described above, optionally, blended with other polymers, additives, processing aids, etc.

For example, in a class of embodiments, the cast film may comprise two or more layers, such as three to nine layers, preferably, three to five layers. The two or more layers may comprise at least one skin layer, a core layer, and optionally, one or more intermediary layers. Each layer may comprise a “neat” polymer with optional processing aids and/or additives or may comprise a blend of polymers with optional processing aids and/or additives.

The at least one of the skin layer, the core layer, or optional intermediary layer may comprise from 1 wt % to 100 wt %, from 30 wt % to 100 wt %, from 40 wt % to 100 wt %, from 50 wt % to 100 wt %, from 60 wt % to 100 wt %, from 65 wt % to 100 wt %, from 70 wt % to 100 wt %, from 75 wt % to 100 wt %, from 85 wt % to 100 wt %, or from 90 wt % to 100 wt %, of the polyethylene polymer, based upon the total weight of the respective skin layer, the core layer, or optional intermediary layer.

In a class of embodiments, the at least one of the skin layer, the core layer, or optional intermediary layer, may further comprise, for example, in a blend, at least one different polyethylene polymer and/or a polypropylene polymer.

### Additives

The polymers and compositions described above may be used in combination with the following additives and other components.

### First Antioxidant

The first antioxidant comprises one or more antioxidants. They include, but are not limited to, hindered phenols, for example, octadecyl-3-(3,5-di-tert.butyl-4-hydroxyphenyl)-propionate (CAS 002082-79-3) commercially available as IRGANOX™ 1076, pentaerythritol tetrakis (3-(3,5-di-tert-butyl-4-hydroxyphenyl)propionate) (CAS 6683-19-8) commercially available as IRGANOX™ 1010; and combinations thereof.

They may be combined with one or more polymers in range from 100 to 4000 parts by weight of the first antioxidant, based on one million parts of the polymer or polymer composition; alternatively, from 250 to 3000 parts by weight of the first antioxidant, based on one million parts of the polymer or polymer composition, alternatively, from 500 to 2500 parts by weight of the first antioxidant, based on one million parts of the polymer or polymer composition, alternatively, from 750 to 2500 parts by weight of the first antioxidant, based on one million parts of the polymer or polymer composition, alternatively, from 750 to 2000 parts by weight of the first antioxidant, based on one million parts of the polymer or polymer composition, and alternatively, from 1000 to 2000 parts by weight of the first antioxidant, based on one million parts of the polymer or polymer composition.

### Second Antioxidant

The second antioxidant comprises one or more antioxidants. They include, but are not limited to, liquid phosphites, such as C₂-C₇, preferably C₂-C₄, and alkyl aryl phosphites mixed structures. Non-limiting examples include mono-amylphenyl phosphites, di-amylphenyl phosphites, dimethylpropyl phosphites, 2-methylbutanyl phosphites, and combinations thereof. In several embodiments of the invention, the second antioxidant may also be represented by the formula [4-(2-methylbutan-2-yl)phenyl]ₓ[2,4-bis(2-methylbutan-2-yl)phenyl]₃₋ₓ phosphate, wherein x=0, 1, 2, 3, or combinations thereof.

Such antioxidants and their use with polyolefin polymers have been described in U.S. Publication Nos. 2005/0113494; 2007/0021537; 2009/0326112; 2013/0190434; 2013/225738; 2014/0045981; U.S. Pat. Nos. 5,254,709; 6,444,836; 7,888,414; 7,947,769; 8,008,383; 8,048,946; 8,188,170; and 8,258,214. An example of a commercially available liquid phosphite is sold under the tradename WESTON™ 705 (Addivant, Danbury, Conn.).

The second antioxidant may be combined with one or more polymers in the range from 100 to 4000 parts by weight of the second antioxidant, based on one million parts of the polymer or polymer composition; alternatively, from 250 to 3000 parts by weight of the second antioxidant, based on one million parts of the polymer or polymer composition; alternatively, from 300 to 2000 parts by weight of the second antioxidant, based on one million parts of the polymer or polymer composition; alternatively, from 400 to 1450 parts by weight of the second antioxidant, based on one million parts of the polymer or polymer composition; alternatively, from 425 to 1650 parts by weight of the second antioxidant, based on one million parts of the polymer or polymer composition; and alternatively, from 1 to 450 parts by weight of the second antioxidant, based on one million parts of the polymer or polymer composition.

The polymers and/or compositions comprising the first antioxidant and/or the second antioxidant described above may be used in combination with the following neutralizing agents, additional additives and other components.

### Neutralizing Agents

One or more neutralizing agents (also called catalyst deactivators) include, but are not limited to, calcium stearate, zinc stearate, calcium oxide, synthetic hydrotalcite, such as DHT4A, and combinations thereof.

### Additional Additives and Other Components

Additional additives and other components include, but are limited to, fillers (especially, silica, glass fibers, talc, etc.) colorants or dyes, pigments, color enhancers, whitening agents, cavitation agents, anti-slip agents, lubricants, plasticizers, processing aids, antistatic agents, antifogging agents, nucleating agents, stabilizers, mold release agents, and other antioxidants (for example, hindered amines and phosphates). Nucleating agents include, for example, sodium benzoate and talc. Slip agents include, for example, oleamide and erucamide.

In a class of embodiments, the one or more layers or the cast films cast films may comprise one or more of fillers, pigments, slip additives/agents, colorants or dyes, color enhancers, whitening agents, cavitation agents, lubricants, plasticizers, processing aids, antifogging agents, nucleating agents, stabilizers, mold release agents, or antioxidants.

### End Use Applications

Any of the polymers and compositions in combination with the additives and other components described herein may be used in a variety of end-use applications. Such end uses may be produced by methods known in the art. Exemplary end-use applications include but are not limited to cast films. As used herein, “cast film” refers to a film having a thickness of at least 0.1 mil or more, monolayer or multilayer, made from at least in-part from one or more polyolefin resins. In other embodiments, the cast film may have a thickness of from 0.1 mil to 25 mil, from 0.1 mil to 20 mil, from 0.5 mil to 20 mil, from 0.75 mil to 15 mil, or from 1.0 mil to 10 mil.

Cast films may be prepared by any conventional technique known to those skilled in the art. See, for example, U.S. Pat. No. 9,321,911 and U.S. Publication Nos. 2015/0225520 and 2015/0376354. In general, cast films are extruded from a flat die onto a chilled roll(s) or a nipped roll, optionally, with a vacuum box and/or air-knife. The cast films may be monolayer or coextruded multi-layer films obtained by various extrusion techniques through a single or multiple dies. The resultant films may be the used as-is or may be laminated to other films or substrates, for example by thermal, adhesive lamination, or direct extrusion onto a substrate. The resultant films and laminates may be subjected to other forming operations such as embossing, stretching, and/or thermoforming. Surface treatments such as corona may be applied and the films may be printed.

As an example, in a cast film extrusion process, a film is extruded through a slit onto a chilled, highly polished turning roll, where it is quenched from one side. The speed of the roller controls the draw ratio and final film thickness. The film is then sent to a second roller for cooling on the other side. Finally, it passes through a system of rollers and is wound onto a roll.

In another example, two, three, or more films are coextruded through two or more slits onto a chilled, highly polished turning roll, the coextruded film is quenched from one side. The speed of the roller controls the draw ratio and final coextruded film thickness. The coextruded film is then sent to a second roller for cooling on the other side. Finally, it passes through a system of rollers and is wound onto a roll.

In a class of embodiments, the invention includes a process to produce a cast film, the process comprising: a) melt extruding at least one first polyethylene polymer to form a molten polymer; b) passing the molten polymer through a die to form the cast film; c) cooling the cast film using one or more chill rolls; d) optionally, annealing the cast film and/or treating the cast film with a corona treatment; and e) recovering the cast film; wherein the at least one first polyethylene polymer has a melt index 4.0 g/10 min or less, an orthogonal comonomer distribution, and/or has at least a first peak and at least a second peak in a comonomer distribution analysis. The process may further include co-extruding at least one second polyethylene polymer to form a multilayer cast film; wherein the at least one second polyethylene polymer has a melt index of 4.2 g/10 min or greater and wherein the multilayer cast film comprises a core layer comprising the at least one first polyethylene polymer and one or more skin layers comprising the at least one second polyethylene polymer. The cooling may occur at a temperature of from 0° C. to 33° C., 10° C. to 25° C., or 15° C. to 25° C. The process may comprise a line speed of 400 lb/hr or greater, 500 lb/hr or greater, 750 lb/hr or greater, 1,000 lb/hr or greater, or 1,200 lb/hr or greater.

The cast films may have at least two, at least three, at least four layers, or at least five layers. In one embodiment, the multilayer cast films are composed of three to ten layers. With reference to multilayer cast film structures, the cast films may comprise the same or different layers. The following notation may be used for illustration. Each layer of a cast film is denoted “A” or “B”. Where a cast film includes more than one A layer or more than one B layer, one or more prime symbols (′, ″, ′″, etc.) are appended to the A or B symbol to indicate layers of the same type that can be the same or can differ in one or more properties, such as chemical composition, density, melt index, thickness, etc. Finally, the symbols for adjacent layers are separated by a slash (/). Using this notation, a three-layer cast film having an inner layer of the polyethylene resin or blend between two outer layers would be denoted A/B/A′. Similarly, a five-layer cast film of alternating layers would be denoted A/B/A′/B′/A″. Unless otherwise indicated, the left-to-right or right-to-left order of layers does not matter, nor does the order of prime symbols; e.g., an A/B cast film is equivalent to a B/A cast film, and an A/A′/B/A″ cast film is equivalent to an A/B/A′/A″ cast film.

In any of the embodiments described herein, the cast film may be measured for Dart Drop Impact or Dart Drop Impact Strength (DIS), reported in grams (g), (g/mil), or (g/μm) and measured as in accordance with ASTM D-1709, method B. The dart head is phenolic. It calculates the impact failure weight, i.e., the weight for which 50% of the test specimens will fail under the impact.

In a class of embodiments, the cast films may have a dart drop impact strength (DIS) of ≥150 g/mil, a dart drop impact strength (DIS) of ≥200 g/mil, a dart drop impact strength (DIS) of ≥225 g/mil, a dart drop impact strength (DIS) of ≥250 g/mil, a dart drop impact strength (DIS) of ≥300 g/mil, a dart drop impact strength (DIS) of ≥400 g/mil, a dart drop impact strength (DIS) of ≥500 g/mil, a dart drop impact strength (DIS) of ≥600 g/mil, a dart drop impact strength (DIS) of ≥700 g/mil, a dart drop impact strength (DIS) of ≥800 g/mil, or a dart drop impact strength (DIS) of 900 g/mil.

In any of the embodiments described herein, the cast film may be measured for Elmendorf tear resistance or strength, reported in grams (g) and measured as in accordance with ASTM D-1922. In a class of embodiments, the cast films may have a Elmendorf tear resistance of 100 g or greater in the machine direction (MD), 150 g or greater in the machine direction (MD), 200 g or greater in the machine direction (MD), 250 g or greater in the machine direction (MD), 300 g or greater in the machine direction (MD), 350 g or greater in the machine direction (MD), 400 g or greater in the machine direction (MD), 500 g or greater in the machine direction (MD), or 600 g or greater in the machine direction (MD).

In any of the embodiments described herein, the cast film may be measured for puncture resistance, reported in (in-lb/mil) and measured with a United Testing Machine SFM-1 and the following method. The test measures the force and energy necessary to puncture a plastic film between a gauge of 0.20 to 10.0 mils. A film sample is placed in the circular clamp approximately 4 inches wide. A plunger/probe with a ¾″ tip is pressed through it at a constant speed of 10 in/min. (2) HDPE slip sheets are placed between the specimen and the probe. This simulates the poking of a finger or bottle through a plastic film. The specimen is tested until failure and (5) specimens are tested and the following data is collected: Peak Load (lbs), Peak/min (lbs/mil), Break Energy (inch-lbs), and Break Energy/mil(in-lbs/mil).

In a class of embodiments, the cast films may have a puncture resistance of 5.00 in-lb/mil or greater, 6.00 in-lb/mil or greater, 7.00 in-lb/mil or greater, 9.00 in-lb/mil or greater, 10.00 in-lb/mil or greater, 12.00 in-lb/mil or greater, 15.00 in-lb/mil or greater, or 17.00 in-lb/mil or greater.

The cast films and laminates made thereof may be used for a variety of purposes, for example, food packaging (dry foods, fresh foods, frozen foods, liquids, processed foods, powders, granules), for packaging of detergents, toothpaste, towels, for labels and release liners. The cast films may also be used in unitization and industrial packaging, notably in stretch films. The cast films are also suitable in hygiene and medical applications, for example in breathable and non-breathable films used in diapers, adult incontinence products, feminine hygiene products, and ostomy bags.

### Test Methods

The properties cited below were determined in accordance with the following test procedures. Where any one of these properties is referenced in the appended claims, it is to be measured in accordance with the following, specified test procedure.

1% Secant Modulus

For 1% Secant Modulus, MPa (psi) a method based upon ASTM-D882-10 was utilized. The test was conducted on the United testing systems, six (6) station, and 60 Degree machine. The specimens are conditioned and tested under ASTM conditions. They are maintained at 23° C.±2° C. and 50%±10% relative humidity. Conditioning time is a minimum of 40 hours and 48 hours after manufacturing. A total of 12 specimens of each material; six in the machine direction (MD) and six in the transverse direction (TD) were tested. The average 1% Secant Modulus (MD_{average}+TD_{average}/2) is calculated in psi (English unit).

Tensile Strength

The tensile test for 250 microns (10 mil) and higher gauge films were conducted according to ASTM D882-12 with sample preparation and reporting procedures based upon ASTM E154-08a and ASTM E1745-11 respectively. The average tensile strength at break (lbf/in of width), average tensile strength at break (psi), and average elongation at break (%) are calculated for the machine and transverse direction.

Dart Drop Impact Strength

The dart impact resistance for 250 microns (10 mil) and higher gauge films were measured by the Free-Falling Dart method (ASTM D1709-15a, Method B, stainless steel). The test was conducted at 23° C., 50% relative humidity after conditioning the samples at 40+ hrs @ 23° C. and 50% relative humidity. For the test, the impact failure weight (F₅₀, grams), the weight at which 50% failure and 50% pass occurs is reported. F=0 or F₀ is defined as the maximum drop weight possible on the instrument at which the samples reported all 10 pass (with 0 failure).

Elmendorf Tear

The tear test of 125 microns (5 mil) film cast films in the machine and transverse direction was tested using a ProTear Elmendorf Tearing Tester based upon ASTM D 1922-15 method. The average tear (MD_{average}+TD_{average}/2) is reported in grams.

Puncture Resistance was performed as state above.

### Examples

It is to be understood that while the invention has been described in conjunction with the specific embodiments thereof, the foregoing description is intended to illustrate and not limit the scope of the invention. Other aspects, advantages and modifications will be apparent to those skilled in the art to which the invention pertains.

Therefore, the following examples are put forth so as to provide those skilled in the art with a complete disclosure and description and are not intended to limit the scope of that which the inventors regard as their invention.

EXCEED™ and EXCEED XP™ resins (available from ExxonMobil Chemical Company, Houston, Tex.) were formulated and processed into three layer cast films utilizing a Black Clawson cast film line having the structure 1:4:1. They were also evaluated against formulations based on non-metallocene type resins commonly used in cast film production, primarily Z/N LLDPE & LDPE blends. LD200 and LL3404 are also available from ExxonMobil Chemical Company as ExxonMobil™ LDPE (7.5 MI) and ExxonMobil™ LLDPE (2.0 MI), respectively. The specific formulations are provided below in Table 1.

TABLE 1

| Film Name | # | Skins | Core |
|---|---|---|---|
| EXCEED 4518 (4.5 MI) Skin + | 209333 | EXCEED 4518 PA | Ext 656A (97 wt %) + |
| EXCEED XP ™ 656A (0.5 MI) | | (97 wt %) + BCT | BCT 209275 (3 wt %) |
| core (inventive) | | 209275* (3 wt %) | |
| EXCEED 3812 (3.8 MI) Skin | 209334 | EXCEED 3812 CB | 60/40 blend |
| | | (97 wt %) + BCT | LD200.48/LL 3404 AH |
| | | 209275 (3 wt %) | (97 wt %) + BCT209275 |
| | | | (3 wt %) |
| EXCEED 3812 (3.8 MI) + LDPE | 209336 | EXCEED 3812CB | 60/40 blend |
| Skin | | (87 wt %) + BCT | LD200.48/LL 3404AH |
| | | 209275 (3 wt %) + | (97 wt %) + BCT 209275 |
| | | LD 200.48 (10 wt %) | (3 wt %) |

*BCT209275: 5 wt % Erucamide Slip Additive Masterbatch

EXCEED XP™ resins were used in the core (Center) and a higher melt index (I₂) EXCEED resin was used in both outer layers (Skin). Also, cast films were made using a Z/N LLDPE & LDPE (core layer) along with a higher melt index (I₂) EXCEED skin. All the film samples had Erucamide Slip Additive which is the amide of C₂₂ mono-unsaturated erucic acid. Processing conditions and film performance data is provided in Table 2.

TABLE 2

| | | Sample ID | | |
|---|---|---|---|---|
| Material | Method Used | BCT-209333 | BCT-209334 | BCT-209336 |
| Gauge Mic (mils) | | | | |
| Average | ASTM D6988-13 | 1.36 | 1.33 | 1.34 |
| Low | | 1.14 | 1.17 | 1.05 |
| High | | 1.57 | 1.54 | 1.59 |
| 1% Secant (psi) | | | | |
| MD | Stated above | 17,465 | 24,789 | 27,902 |
| TD | | 18,523 | 33,402 | 33,575 |
| Tensile | | | | |
| Yield Strength(psi) | | | | |
| MD | Stated above | 1139 | 1,603 | 1,682 |
| TD | | 1113 | 1,338 | 1,517 |
| Elongation @ Yield (%) | | | | |
| MD | | 8.4 | 7.1 | 7.7 |
| TD | | 7.3 | 4.4 | 6.3 |
| Tensile Strength (psi) | | | | |
| MD | | 8666 | 4,135 | 3,993 |
| TD | | 6896 | 4,605 | 4,626 |
| Elongation @ Break (%) | | | | |
| MD | | 366 | 456 | 435 |
| TD | | 698 | 660 | 711 |
| Elmendorf Tear | | | | |
| MD (g) | Stated above | 512 | 122 | 107 |
| TD (g) | | 437 | 551 | 555 |
| Haze (%) | ASTM D1003 | 2.4 | 2.7 | 4.1 |
| Gloss (GU) | | | | |
| MD | ASTM D2457 | 86 | 87 | 77 |
| TD | | 86 | 87 | 76 |
| Dart Drop | | | | |
| Phenolic | Stated above | | | |
| Method A | | | | |
| (g) | | 1226 | 149 | 107 |
| (g/mil) | | 901 | 112 | 80 |
| Puncture | | | | |
| BTEC Probe | Stated above | | | |
| Peak Force (lbs) | | 11.12 | 6.75 | 5.94 |
| Peak Force (lbs/mil) | | 8.18 | 5.08 | 4.43 |
| Break Energy (in-lbs) | | 24.62 | 8.82 | 6.36 |
| Break Energy (in-lbs/mil) | | 18.10 | 6.63 | 4.74 |

EXCEED XP™ based cast films demonstrated superior physical properties when compared to the Z/N LLDPE & LDPE blends. As demonstrated, the film based on EXCEED XP™ (core layer) demonstrated exceptionally high Dart, Puncture, & MD Tear values along with superior clarity. Without being bound to theory, it is believed that the unique molecular architecture of EXCEED XP™ and its BOCD structure is a key parameter in enhancing the physical properties. The same in conjunction with a higher melt index (I₂) EXCEED resin converted easily on the cast film line where fractional melt index (I₂) resins are typically a challenge to run.

In particular, EXCEED XP Core (BCT 209333) versus Z/N LL/LD Core (BCT 209334) samples demonstrated 400% higher MD Tear, 800% higher Dart Drop, 275% higher puncture resistance, and superior clarity, around 12.5% lower Haze. EXCEED XP Core (BCT 209333) versus Z/N LL/LD Core+LD in skins (BCT 209336) demonstrated more than 1000% higher Dart Drop, 400% higher puncture, superior clarity, around 40% lower Haze (LD addition had a detrimental affect on some properties but was added to improve optical properties). Thus, cast films made with EXCEED XP 8656 outperformed the other films and some of the physical properties as observed met or even exceeded typical values of conventional cast films.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the invention, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All priority documents are herein fully incorporated by reference for all jurisdictions in which such incorporation is permitted and to the extent such disclosure is consistent with the description of the present invention. Further, all documents and references cited herein, including testing procedures, publications, patents, journal articles, etc. are herein fully incorporated by reference for all jurisdictions in which such incorporation is permitted and to the extent such disclosure is consistent with the description of the present invention.

While the invention has been described with respect to a number of embodiments and examples, those skilled in the art, having benefit of this disclosure, will appreciate that other embodiments can be devised which do not depart from the scope and spirit of the invention as disclosed herein.

What is claimed is:

1. A cast film comprising the product of the combination of:
a) a core layer comprising at least one first polyethylene polymer having a melt index of 4.0 g/10 min or less, wherein the at least one first polyethylene polymer has an orthogonal comonomer distribution and/or has at least a first peak and at least a second peak in a comonomer distribution analysis; and
b) one or more skin layers comprising at least one second polyethylene polymer having a melt index of 4.2 g/10 min or greater.

2. The cast film of claim 1, wherein the at least one first polyethylene polymer has a melt index of from 0.1 g/10 min to 3.5 g/10 min.

3. The cast film of claim 1, wherein the at least one first polyethylene polymer has a melt index of from 0.1 g/10 min to 2.0 g/10 min.

4. The cast film of claim 1, wherein the at least one first polyethylene polymer has a melt index of from 0.2 g/10 min to 1.0 g/10 min.

5. The cast film of claim 1, wherein the at least one second polyethylene polymer has a melt index of from 4.5 g/10 min to 10.0 g/10 min.

6. The cast film of claim 1, wherein the at least one second polyethylene polymer has a melt index of from 4.5 g/10 min to 9.0 g/10 min.

7. The cast film of claim 1, wherein the at least one second polyethylene polymer has a melt index of from 4.5 g/10 min to 7.0 g/10 min.

8. The cast film of claim 1, wherein the at least one first polyethylene polymer has one or more of the following properties:
a) a density of from 0.910 g/cm³ to 0.945 g/cm³;
b) a branching index g′ᵥᵢₛ≥0.980;
c) a melt index ratio (I₂₁/I₂) of from 10 to 50;
d) a hafnium content of 5.0 ppm or less; and
e) a ratio of hafnium to zirconium (ppm/ppm) of at least 2.

9. The cast film of claim 1, wherein the at least one first polyethylene polymer and the at least one second polyethylene polymer are both metallocene-catalyzed polyethylene polymers.

10. The cast film of claim 1, wherein the cast film further comprises one or more of fillers, pigments, slip additives/agents, colorants or dyes, color enhancers, whitening agents, cavitation agents, lubricants, plasticizers, processing aids, antifogging agents, nucleating agents, stabilizers, mold release agents, or antioxidants.

11. The cast film of claim 1, wherein the cast film has a thickness of from 0.1 mil to 20 mil.

12. The cast film of claim 1, wherein the cast film is a multilayer film and comprises from 3 to 9 layers.

13. The cast film of claim 12, wherein the multilayer film comprises from 3 to 5 layers.

14. The cast film of claim 1, wherein the cast film has an Elmendorf tear resistance (ASTM D 1922) of 200 g or greater in the machine direction.

15. The cast film of claim 1, wherein the cast film has an Elmendorf tear resistance (ASTM D 1922) of 500 g or greater in the machine direction.

16. The cast film of claim 1, wherein the cast film has a dart drop impact resistance F₅₀ (ASTM D 1709, Method A) of 200 g/mil or greater.

17. The cast film of claim 1, wherein the cast film has a dart drop impact resistance F₅₀ (ASTM D 1709, Method A) of 800 g/mil or greater.

18. The cast film of claim 1, wherein the cast film has a puncture resistance of 7.00 in-lb/mil or greater.

19. The cast film of claim 1, wherein the cast film has a puncture resistance of 15.00 in-lb/mil or greater.

20. A process to produce a cast film, the process comprising:
a) melt extruding at least one first polyethylene polymer to form a molten polymer;
b) passing the molten polymer through a die to form the cast film;
c) cooling the cast film using one or more chill rolls;
d) optionally, annealing the cast film and/or treating the cast film with a corona treatment; and
e) recovering the cast film,
wherein the at least one first polyethylene polymer has a melt index 4.0 g/10 min or less, an orthogonal comonomer distribution, and/or has at least a first peak and at least a second peak in a comonomer distribution analysis.

21. The process of claim 20, further comprising co-extruding at least one second polyethylene polymer to form a multilayer cast film; wherein the at least one second polyethylene polymer has a melt index of 4.2 g/10 min or greater and wherein the multilayer cast film comprises a core layer comprising the at least one first polyethylene polymer and one or more skin layers comprising the at least one second polyethylene polymer.

22. The process of claim 20, the at least one first polyethylene polymer has one or more of the following properties:
a) a density of from 0.910 g/cm³ to 0.945 g/cm³;
b) a branching index g′ᵥᵢₛ≥0.980;
c) a melt index ratio (I₂₁/I₂) of from 10 to 50;
d) a hafnium content of 5.0 ppm or less; and
e) a ratio of hafnium to zirconium (ppm/ppm) of at least 2.

23. The process of claim 20, wherein the at least one first polyethylene polymer and the at least one second polyethylene polymer are both metallocene-catalyzed polyethylene polymers.

24. The process of claim 20, wherein the cooling occurs at a temperature of from 15° C. to 25° C.

25. The process of claim 20, wherein the process comprises a line speed of 500 lb/hr or greater.
